(19) United States
(12) Patent Application Publication
(10) Pub. No.: US 2011/0063498 A1
(43) Pub. Date: Mar. 17, 2011

(54) CAMERA MODULE FOR VEHICLES

(76) Inventors: Bok Sun AN, Gyunggi-do (KR); Moon Do YI, Gyunggi-do (KR); Won Gi PARK, Seoul (KR)

(21) Appl. No.: 12/609,870

(22) Filed: Oct. 30, 2009

(30) Foreign Application Priority Data
Sep. 14, 2009 (KR) 10-2009-0086356

(51) Int. Cl. H04N 5/225

(52) U.S. Cl. 348/375; 348/E05.024

(57) ABSTRACT

Disclosed herein is a camera module for vehicles. The camera module includes an upper housing accommodating at least one lens which brings an image of a subject into focus. A circuit board has an image sensor mounted thereon. The image sensor converts the image received through the lens into an electric signal. A lower housing is fastened to the upper housing, thus sealing an internal space receiving the image sensor and the circuit board. The camera module reduces the number of fastened parts, thus improving waterproof performance and assemblability.

### CROSS REFERENCE TO RELATED APPLICATION

This application claims the benefit of Korean Patent Application No. 10-2009-0086356, filed on Sep. 14, 2009, entitled “Camera Module For Automobile”, which is hereby incorporated by reference in its entirety into this application.

### BACKGROUND OF THE INVENTION

1. Technical Field

The present invention relates to a camera module for vehicles.

2. Description of the Related Art

Generally, mirrors are attached to predetermined portions of a vehicle to allow a desired direction or place including the front side, the right and left sides, the rear side and the interior of the vehicle to be viewed from a driver's seat when the vehicle is being driven. However, since the minors have the narrow field of view and cannot be seen when an obstacle is placed between the mirrors and a driver, the installing positions of the mirrors are restricted. Further, since the mirrors are installed at different positions, it is impossible to observe several directions with a single look and a driver must turn his or her head in respective directions, so that it is not easy to view them. While the driver watches one direction through any one of the minors, he or she may neglect to watch another direction, thus causing an unexpected accident.

A video monitoring system using a camera, in place of the mirrors of the vehicle, is known to those skilled in the art. That is, the camera is installed in place of the minors or the camera as well as the mirrors is installed, and a monitor in the form of a CCTV is installed near the driver's seat, so that the driver can watch the rear side by glancing at an image captured by the camera and displayed on the monitor.

FIG. 1 is a vertical perspective view illustrating the internal structure of a conventional camera module for vehicles. Hereinafter, the conventional camera module 10 for vehicles will be described with reference to the drawing.

As shown in FIG. 1, the conventional camera module 10 for vehicles includes a lens barrel 20, an upper housing 30, a circuit board 40, and a lower housing 60.

The lens barrel 20 functions to bring an image of a subject incident on a lens into the camera module 10, and comprises a hollow cylindrical lens receptor having an internal to space of a predetermined size such that at least one lens is arranged along an optical axis.

Here, the lens barrel 20 has on its outer circumference an external threaded part and is fastened to the upper housing 30 in a threaded manner. After a focusing operation is performed using vertical movement generated by rotating the lens barrel 20, the lens barrel 20 is attached to the upper housing 30 using additional adhesive means.

The upper housing 30 is an assembly receptor which holds the lens barrel 20, and has the shape of a square box. An inner opening is formed through the central portion of the upper housing 30, and the lens barrel 20 is accommodated in the inner opening. The upper housing 30 is adhered to the circuit board 40 using an adhesive.

The circuit board 40 functions to transmit an electric signal from the image sensor 50, which is electrically connected to the upper surface of the circuit board 40, to a mobile device such as a camera phone, a PDA or a notebook computer. The circuit board 40 is coupled to the upper housing 30.

The lower housing 60 is fastened to the upper housing 30 to seal internal components including the circuit board 40 and the image sensor 50, and is coupled to the upper housing 30 using an adhesive. Here, the lower housing 60 may be provided with a connector 70 which connects the camera module with an external device.

However, the conventional camera module 10 for vehicles is problematic in that there are many fastened parts, so that waterproof performance is low. That is, the conventional camera module 10 is problematic in that it inevitably has a first fastened part of the lens barrel 20 with the upper housing 30 and a second fastened part of the upper housing 30 with the lower housing 60, so that waterproof performance is reduced at the fastened parts. Particularly, since the camera module 10 for vehicles is exposed to the outside when it is in use, the entire reliability of the camera module may be considerably reduced if the waterproof performance is lowered. Further, if the camera module 10 has many fastened parts, fastening operations must be performed several times, so that assemblability is low.

### SUMMARY OF THE INVENTION

The present invention is intended to provide a camera module for vehicles, which reduces the number of fastened parts, thus improving waterproof performance and assemblability.

In an exemplary camera module for vehicles according to an embodiment of the present invention, an upper housing accommodates at least one lens which brings an image of a subject into focus. A circuit board has an image sensor mounted thereon, the image sensor converting the image received through the lens into an electric signal. A lower housing is fastened to the upper housing, thus sealing an internal space receiving the image sensor and the circuit board.

The upper housing may be integrated with a barrel part which has an inner opening for accommodating the lens.

Further, the upper housing and the lower housing may have a cylindrical structure, and may be fastened to each other in a threaded manner.

Parts of the upper housing and the lower housing which are fastened to each other in a threaded manner may be adhered using adhesive means.

Further, an external threaded part may be formed on an outer circumference of the upper housing, and an internal threaded part may be formed on an inner circumference of the lower housing to engage with the external threaded part.

An external threaded part may be formed on an outer circumference of the lower housing, and an internal threaded part may be formed on an inner circumference of the upper housing to engage with the external threaded part.

Further, the circuit board may be fastened to the lower housing.

The lower housing may be provided with an inner step for supporting the circuit board, and the circuit board may be coupled to the inner step using a screw.

Further, the upper housing may have an IR filter therein.

Furthermore, a connector for forming a connection with an external device may be fastened to the lower housing.

### BRIEF DESCRIPTION OF THE DRAWINGS

FIG. 1 is a vertical perspective view illustrating the internal structure of a conventional camera module for vehicles; and

FIG. 2 is a vertical perspective view illustrating the internal structure of a camera module for vehicles according to a preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the terms to describe most appropriately the best method he or she knows for carrying out the invention.

The above and other objects, features and advantages of the present invention will be more clearly understood from the following detailed description taken in conjunction with the accompanying drawings. Herein, the same reference numerals are used to throughout the different drawings to designate the same components. Further, when it is determined that the detailed description of the known art related to the present invention might obscure the gist of the present invention, the detailed description thereof will be omitted.

Hereinafter, the preferred embodiment of the present invention will be described in detail with reference to the accompanying drawings.

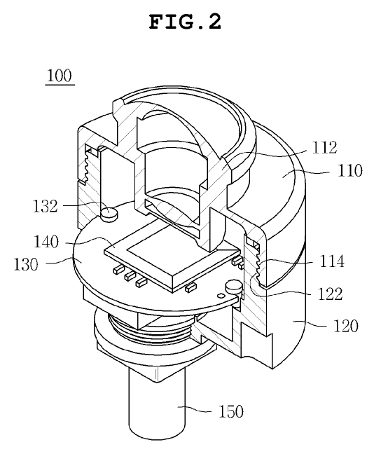

FIG. 2 is a vertical perspective view illustrating the internal structure of a camera module for vehicles according to a preferred embodiment of the present invention. Hereinafter, a camera module 100 for vehicles according to this embodiment will be described with reference to the drawing.

As shown in FIG. 2, the camera module 100 for vehicles according to this embodiment includes an upper housing 110, a circuit board 130, and a lower housing 120.

The upper housing 110 provides a space for accommodating a lens, and is fastened to the lower housing 120, thus providing a sealing space for protecting internal components from the external environment.

Here, the upper housing 110 is integrated with a barrel part 112 which accommodates the lens therein. Such a structure reduces the number of fastened parts, and improves waterproof performance. The structure may be achieved by changing an injection molding process. The lens is accommodated in the barrel part 112 to be secured thereto.

The barrel part 112 is formed to have an inner opening of a predetermined size such that at least one lens is arranged along an optical axis, and is provided with a spacer (not shown) which is disposed between a plurality of lenses such that they are spaced apart from each other by a predetermined interval. Further, a cap is provided on the upper end of the barrel part 112 to hold the lenses arranged along the optical axis. Preferably, an incident hole of a predetermined size, corresponding to the center of the lens, is formed through the center of the front of the cap.

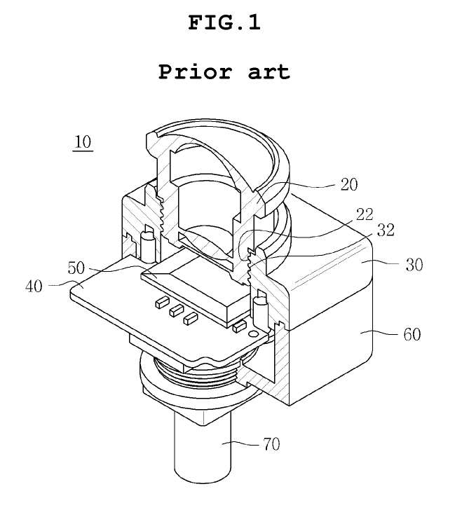

Further, the upper housing 110 has a cylindrical structure of a size which may wholly cover internal components including the circuit board 130 and an image sensor 140, and an external threaded part 114 is formed on the outer circumference of the upper housing 110. According to the conventional camera module, as shown in FIG. 1, the lens barrel 20 having on its outer circumference the external threaded part and the upper housing 30 on its inner circumference the internal threaded part are fastened to each other in a threaded manner, so that the lens barrel 20 is moved vertically, thus achieving the auto-focusing function. However, according to the present invention, the upper housing 110 is integrated with the barrel part 112 into a single structure, so that the auto-focusing function cannot be achieved by the vertical movement of the barrel part 112. Thus, the external threaded part is formed on the outer circumference of the upper housing 110, and the upper housing 110 is fastened to the lower housing 120, so that, when the fastening operation is performed through the vertical movement of the upper housing 110, the auto-focusing function is achieved. In this case, in order to achieve the vertical movement through the rotation of the upper housing 110, the upper housing 110 has a cylindrical structure. Further, in order to achieve the auto-focusing function, the upper housing 110 has on its outer circumference the external threaded part 114. Here, parts fastened in a threaded manner are adhered to each other using an adhesive means such as rubber or an adhesive after auto focusing.

Hereinbefore, an embodiment wherein the external threaded part is provided on the outer circumference of the upper housing 110 has been described. However, the upper housing 110 may have an internal threaded part. In this case, the lower housing 120 has on its outer circumference an external threaded part. Such a construction also falls within the scope of the present invention.

Further, an IR filter (not shown) is installed in the housing 120 to filter infrared to rays included in a light beam incident on the lens or to prevent impurities from falling onto the image sensor 140. Preferably, the IR filter is placed on the same axis as at least one lens provided in the upper housing 110 and the image sensor 140.

The circuit board 130 functions to transmit an electric signal, generated from the image sensor 140 which is electrically connected to the upper surface of the circuit board 130, to a mobile device such as a camera phone, a PDA or a notebook computer.

Here, the image sensor 140 serves to convert an image into an electric signal. An image formation area is provided on the central portion of the upper surface of the image sensor 140, and a sensor pad is provided on the edge of the image sensor 140 to be connected to the pad of the circuit board 130 via a wire. The image sensor 140 is attached to the central portion of the upper surface of the circuit board 130 using an adhesive. Meanwhile, the image sensor 140 may be mounted on the circuit board 130 through a flip-chip bonding method as well as a wire bonding method.

A plurality of chip devices is mounted on the circuit board 130 and digitizes an image signal output from the image sensor 140. Especially, a passive component such as an MLCC for eliminating noise generated during the operation of a camera is mounted on the circuit board 130. The chip devices are mounted on the edge of the circuit board 130.

Meanwhile, the circuit board 130 is supported by an inner step of the lower housing 120 which will be described below in detail, and is fastened to the inner step using a screw 132. According to the conventional camera module, the circuit board 130 is fastened to the upper housing 110. However, according to the present invention, the auto focusing of the lens relative to the image sensor 140 is achieved through the coupling of the upper housing 110 with the lower housing 120 in a threaded manner. Thus, if the circuit board 130 is coupled to the upper housing 110, it is impossible to adjust a distance between the lens and the image sensor 140. Hence, it is preferable that the circuit board 130 be coupled to the lower housing 120. FIG. 2 illustrates an embodiment wherein the to circuit board 130 is coupled to the lower housing 120 using the screw. But, the circuit board may be adhered to the lower housing adhesive means.

The lower housing 120 is fastened to the upper housing 110, thus providing an internal space which accommodates the internal components including the circuit board 130 and the image sensor 140.

Here, the lower housing 120 has a cylindrical structure of a size which may wholly cover the internal components including the circuit board 130 and the image sensor 140. The internal threaded part 122 is formed on the inner circumference of the lower housing 120.

Preferably, the lower housing 120 has on its inner circumference the inner step for supporting the circuit board 130. In the state where the circuit board 130 is supported by the inner step, the circuit board 130 is preferably coupled to the lower housing 120 using the screw 132.

Meanwhile, a connector part 150 such as a cable for the connection of the cameral module with an external device is fastened to the lower portion of the lower housing 120.

As described above, the present invention provides a camera module for vehicles, in which a lens barrel and an upper housing are integrated into each other unlike a conventional camera module, thus reducing the number of fastened parts. Thus, the waterproof performance and assemblability of the camera module for vehicles are improved. Further, an upper housing structure according to the present invention obviates the necessity of separately manufacturing the lens barrel, thus reducing the cost of materials.

Further, the present invention provides a camera module for vehicles, which is capable of performing an auto-focusing function by fastening an upper housing to a lower housing in a threaded manner, and of performing auto-focusing operation when the upper housing is fastened to the lower housing, thus simplifying work.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

Accordingly, such modifications, additions and substitutions should also be understood as falling within the scope of the present invention.

What is claimed is:

1. A camera module for vehicles, comprising:
an upper housing accommodating at least one lens which brings an image of a subject into focus;
a circuit board on which an image sensor is mounted, the image sensor converting the image received through the lens into an electric signal; and
a lower housing fastened to the upper housing, thus sealing an internal space receiving the image sensor and the circuit board.

2. The camera module as set forth in claim 1, wherein the upper housing is integrated with a barrel part which has an inner opening for accommodating the lens.

3. The camera module as set forth in claim 1, wherein the upper housing and the lower housing have a cylindrical structure, and are fastened to each other in a threaded manner.

4. The camera module as set forth in claim 3, wherein parts of the upper housing and the lower housing which are fastened to each other in a threaded manner are adhered using adhesive means.

5. The camera module as set forth in claim 3, wherein an external threaded part is formed on an outer circumference of the upper housing, and an internal threaded part is formed on an inner circumference of the lower housing to engage with the external threaded part.

6. The camera module as set forth in claim 3, wherein an external threaded part is formed on an outer circumference of the lower housing, and an internal threaded part is formed on an inner circumference of the upper housing to engage with the external threaded part.

7. The camera module as set forth in claim 1, wherein the circuit board is fastened to the lower housing.

8. The camera module as set forth in claim 7, wherein the lower housing is provided with an inner step for supporting the circuit board, and the circuit board is coupled to the inner step using a screw.

9. The camera module as set forth in claim 1, wherein the upper housing has an IR filter therein.

10. The camera module as set forth in claim 1, wherein a connector for forming a connection with an external device is fastened to the lower housing.
